(19) United States
(12) Patent Application Publication
(10) Pub. No.: US 2008/0276230 A1
(43) Pub. Date: Nov. 6, 2008

(54) PROCESSING BUNDLE FILE USING VIRTUAL XML DOCUMENT

(75) Inventors: Belinda Ying-Chieh Chang, Cary, NC (US); John R. Hind, Raleigh, NC (US); Robert E. Moore, Durham, NC (US); Brad B. Topol, Cary, NC (US); Jie Xing, Cary, NC (US)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/743,801

(22) Filed: May 3, 2007

(51) Int. Cl. G06F 9/45

(52) U.S. Cl. 717/142

(57) ABSTRACT

A method, system and computer program product for processing a bundle file are disclosed. According to an embodiment, a method for processing a bundle file comprises: parsing the bundle file into bundle entries; creating a virtual XML file element to represent a bundle entry in a virtual XML document; and processing the bundle file using the virtual XML document.

### FIELD OF THE INVENTION

The invention relates generally to bundle file processing, and more particularly to processing a bundle file using a virtual XML document.

### BACKGROUND OF THE INVENTION

Bundle files have been proven to be very useful for various purposes in various application domains. The term “bundle file” refers to a stream of bytes which represents a set of multiple files and the respective relative directory path relationships thereof. A bundle file can be used as a medium for application deployment and installation in a software administration domain, for data collection and transfer in a software technical support domain, and so on. In the use of a bundle file, it may be required to refer to the contents of a file within the bundle file, e.g., reading a configuration value associated with a key in a properties file. In some situations, the contents of a file inside a bundle file may need to be modified, for example, to change a key value in a properties file.

Conventionally, manual processes are used to process a bundle file, which can be automated only by scripting the manual processes with the invocation of the bundle-specific commands. For example, to update a bundle file, a user would need to extract some files from a bundle file, modify these files, and put them back into the bundle file using a series of bundle-file-specific commands and file-format-specific editing procedures. The conventional approaches do not meet the requirements of programmatic retrieval of values and automated update in various application domains.

### BRIEF SUMMARY OF THE INVENTION

A first aspect of the invention is directed to a method for processing a bundle file, the method comprising: parsing the bundle file into bundle entries; creating a virtual XML file element to represent a bundle entry in a virtual XML document; and processing the bundle file using the virtual XML document.

A second aspect of the invention is directed to a system for processing a bundle file, the system comprising: means for parsing the bundle file into bundle entries; and means for creating a virtual XML file element to represent a bundle entry in a virtual XML document; and means for processing the bundle file using the virtual XML document.

A third aspect of the invention is directed to a computer program product stored on a computer readable medium for processing a bundle file, the computer program product comprising: computer usable program code which, when executed by a computer system, enables the computer system to: parse the bundle file into bundle entries; create a virtual XML file element to represent a bundle entry in a virtual XML document; and process the bundle file using the virtual XML document.

A fourth aspect of the invention is directed to a method for deploying a system for processing a bundle file, comprising: providing a computer infrastructure being operable to: parse the bundle file into bundle entries; create a virtual XML file element to represent a bundle entry in a virtual XML document; and process the bundle file using the virtual XML document.

Other aspects and features of the present invention, as defined solely by the claims, will become apparent to those ordinarily skilled in the art upon review of the following non-limiting detailed description of the invention in conjunction with the accompanying figures.

### BRIEF DESCRIPTION OF THE DRAWINGS

The embodiments of this invention will be described in detail, with reference to the following figures, wherein like designations denote like elements, and wherein:

FIG. 1 shows a block diagram of an illustrative computer environment according to an embodiment of the invention.

FIG. 2 shows an embodiment of the operation of a bundle file processing system according to the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1 . Computer Environment

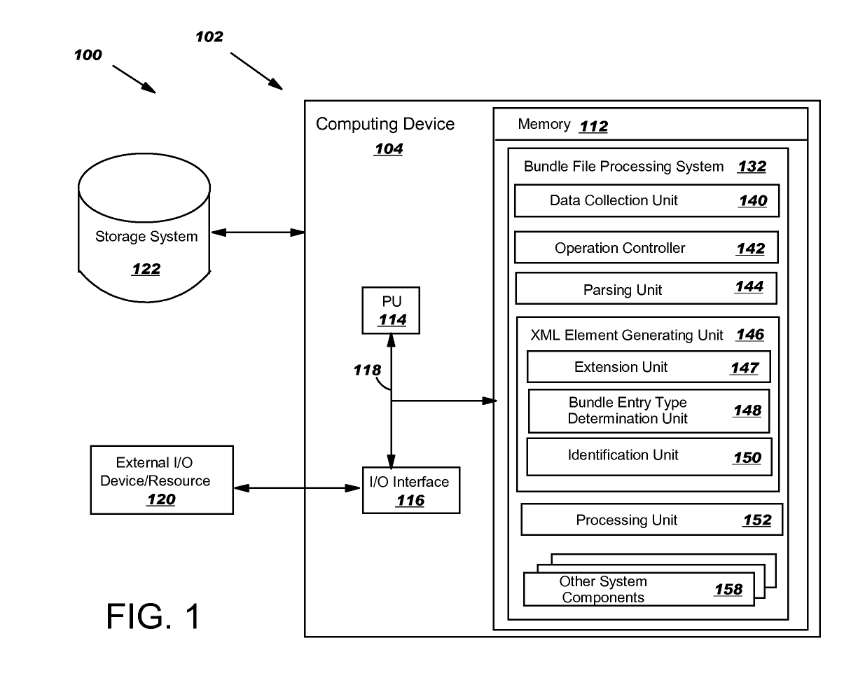

FIG. 1 shows an illustrative environment 100 for processing a bundle file. To this extent, environment 100 includes a computer infrastructure 102 that can perform the various processes described herein for processing a bundle file. In particular, computer infrastructure 102 is shown including a computing device 104 that comprises a bundle file processing system 132, which enables computing device 104 to perform the process(es) described herein.

Computing device 104 is shown including a memory 112, a processing unit (PU) 114, an input/output (I/O) interface 116, and a bus 118. Further, computing device 104 is shown in communication with an external I/O device/resource 120 and a storage system 122. In general, PU 114 executes computer program code, such as bundle file processing system 132, that is stored in memory 112 and/or storage system 122. While executing computer program code, PU 114 can read and/or write data to/from memory 112, storage system 122, and/or I/O interface 116. Bus 118 provides a communications link between each of the components in computing device 104. I/O interface 116 can comprise any device that enables a user to interact with computing device 104 or any device that enables computing device 104 to communicate with one or more other computing devices. External I/O device/resource 120 can be coupled to the system either directly or through I/O interface 116.

In any event, computing device 104 can comprise any general purpose computing article of manufacture capable of executing computer program code installed thereon. However, it is understood that computing device 104 and bundle file processing system 132 are only representative of various possible equivalent computing devices that may perform the various processes of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in an embodiment, computer infrastructure 102 comprises two or more computing devices that communicate over any type of wired and/or wireless communications link, such as a network, a shared memory, or the like, to perform the various processes of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

Bundle file processing system 132 includes a data collection unit 140; an operation controller 142; a parsing unit 144; an XML element generating unit 146 including an extension unit 147, a bundle entry type determination unit 148, and an identification unit 150; a processing unit 152; and other system components 158. Other system components 158 may include any now known or later developed parts of bundle file processing system 132 not individually delineated herein, but understood by those skilled in the art. As should be appreciated, components of computer infrastructure 102 and bundle file processing system 132 may be located at different physical locations or at the same physical location.

Inputs to computer infrastructure 102, e.g., through external I/O device/resource 120 and/or I/O interface 116, may include a bundle file to be processed and a bundle file processing schema referred to as an ‘extension type document’ (ETD), which defines the rules for representing the bundle file with a virtual XML document as will be described herein. Inputs to computer infrastructure 102 may also include additional programs to process a bundle file entry to be represented in the virtual XML document. The operation of bundle file processing system 132 will be described herein in detail.

### 2. Operation Methodology

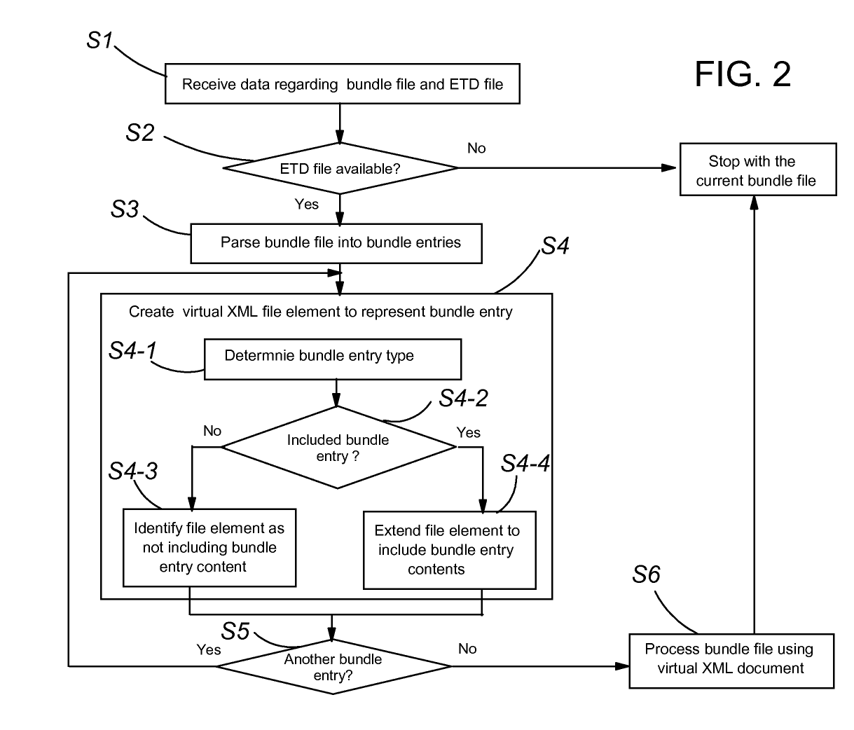

An embodiment of the operation of bundle file processing system 132 is shown in the flow diagram of FIG. 2. Referring to FIGS. 1-2, in process S1, data collection unit 140 collects/receives data regarding a bundle file. The bundle file may be any file that includes multiple files (referred to as bundle entries) and the respective relative directory path relationship thereof. For example, a bundle file might be a traditional archive file, such as a ZIP, CAB, JAR, or TAR file. A bundle file might also be an installation package file such as an RPM or Microsoft MSI®. Microsoft, Windows, Windows NT, and the Windows logo are trademarks of Microsoft Corporation in the United States, other countries, or both. A bundle file may also be a file system store such as an ISO image or a VMDK virtual disk drive. A bundle file may further be some form of object package such as a structured storage container (e.g., a Microsoft Office® document). As should be appreciated, a bundle file can contain other bundle files in the same or different format (for example, a ZIP file might contain a JAR file), and these other bundle files can themselves further contain bundle files in a recursive fashion.

Data collection unit 140 may also receive data regarding an extension type document (ETD). The ETD file is used to determine how a bundle entry in the bundle file will be represented in a virtual XML document. The ETD file may be associated with the respective bundle file in any manner, and all are included in the invention. For example, an ETD file with the name bundle ETD.xml may be placed in the top level directory inside the bundle file such that the ETD file would be available to be used as a default ETD file. The bundle file may also have metadata that points to an ETD file via a value such as an URI.

According to an embodiment, the ETD file includes matching patterns to be matched by the bundle entries of the bundle file. A matching pattern further relates to how the matched bundle file will be processed. For example, an ETD may include one or more <extensionTypeExclude> elements, which identifies bundle entries whose contents will not be included in the virtual XML document for the bundle entry. An ETD may include one or more <extensionTypeinclude> elements, which identifies bundle entries whose contents will be included in the virtual XML document for the bundle entry. An ETD may further include an <import> element, which contains pointers to additional ETD files to be used in processing the associated bundle file. In the processing of the associated bundle file, the contents of all the ETD files, including those referenced recursively via the <import> element, may be logically merged. Other data required for the operation of bundle file processing system 132 may also be collected.

In process S2, operation controller 142 determines whether there is a suitable ETD file for processing the bundle file. If no such ETD file is available, operation controller 142 controls the operation of bundle file processing system 132 to stop with the current bundle file. If there is a suitable ETD file, operation controller 142 controls the operation to go to process S3.

In process S3, parsing unit 144 parses the bundle file into bundle entries. A bundle entry refers to a file contained in the bundle file, which can be generated through one level of parsing of the bundle file. That is, if a higher level bundle file contains a lower level bundle file, the lower level bundle file is a bundle entry of the higher level bundle file. Through one level of parsing of the higher level bundle file, the lower level bundle file will not be parsed. According to an embodiment, parsing unit 144 parses the bundle file based on the rules/instructions of the ETD file. However, this does not limit the scope of the invention.

In process S4, XML element generating unit 146 creates a virtual XML file element to represent a bundle entry of the bundle file in a virtual XML document. A virtual XML document is a document—whether XML or non-XML—that can be viewed and data-processed in a manner similar to processing an XML document. A virtual XML document may keep a file element in the original format most natural for the data, and provide a generic abstract XML interface corresponding to the XML Infoset as well as the forthcoming, e.g., XPath, XQuery and XML SAX data model. Each bundle entry in the bundle file will be represented by a node beginning with a file element in the virtual XML document. The virtual XML document may be of a DOM tree structure or any other structures. According to an embodiment, XML element generating unit 146 uses the ETD file in creating a file element for a bundle entry.

Process S4 may include four sub-processes. In sub-process S4-1, bundle entry type determination unit 148 determines a type of a bundle entry. According to an embodiment, the type of the bundle entry may be determined based on the matching patterns and the processing rule thereof stipulated in the ETD file. For example, the <extensionTypeExclude> element of the ETD file may stipulate that contents of the matching bundle entries are not included in the virtual XML document. Such a bundle entry will be referred to herein as an ‘excluded bundle entry’. The <extensionTypeinclude> element may stipulate that contents of some bundle files are included in the virtual XML document. Such a bundle entry will be referred to herein as an ‘included bundle entry’. For the included bundle entries, the ETD file may further stipulate how the contents are included/represented in the virtual XML document. As such, bundle entry type determination unit 148 categorizes a bundle entry, i.e., determining a bundle entry type, with respect to whether the contents of the bundle entry will be included in the virtual XML document and how the contents will be represented.

In sub-process S4-2, operation controller 142 determines whether a bundle entry is an excluded bundle entry or an included bundle entry. For an excluded bundle entry, operation controller 142 directs the operation to sub-process S4-3; and for an included bundle entry, operation controller 142 directs the operation to sub-process S4-4. In the case that a bundle entry matches the patterns identified by both the <extensionTypeExclude> element and the <extensiontypeinclude> element of the ETD file, a user may instruct, through, e.g., the ETD, regarding which element has the priority. For example, the ETD may stipulate that the <extensionTypeExclude> element has the priority over the <extensionTypeInclude> element such that if a bundle entry type matches patterns stipulated in both elements, the bundle entry will be identified as an excluded bundle entry, and the operation will be directed to sub-process S4-3.

In sub-process S4-3, identification unit 150 identifies the file element representing the bundle entry as not including a content of the bundle entry. Any method may be used for the identification, and all are included in the invention. For example, a file element of the following exemplary form may be used to represent the bundle entry:

<file name=“autopdzip/autopd/autopd.log” type=“inaccessible”/>

In sub-process S4-4, extension unit 147 extends the file element representing the bundle entry to include a representation of content of the bundle entry. The extension may be implemented based on the type of the bundle entry. For example, according to an embodiment, contents of six types of bundle entries may be included in the virtual XML document: XML file, properties file, text file, program-processed file, bundle file, and raw byte stream file. According to an embodiment, in the case the bundle entry is identified as an XML file, extension unit 147 includes the contents of the XML file as a subtree under the respective file element. For example, a file element of the following exemplary form may be used to represent the XML file:

```
<file name=”autopdzip/ibm/portal/config.xml” type=”xml”>
    <! -- ?xml version=”1.0” encoding=”UTF-8”? -->
    <!-- (C) Copyright IBM Corp. 2001 ,2005etc. -->
    <root-element>
            <child1/>
            <child2/>
    <root-element>
</file>
```

In the case the bundle entry is a properties file, extension unit 147 includes an attribute value pair indicating the properties represented by the properties file as child elements under the respective file element. For example, a file element of the following exemplary form may be used to represent the properties file:

```
<file name=”autopdzip/ibm/portal/wpconfig.properties”
    type=“properties“>
    ...
    <comment> #VirtualHostName: The name of the
    WebSphere Application Server virtual host</comment>
    <property name=”VirtualHostName” value=”default_host”/>
    <comment> # WasHome: The directory where WebSphere
    Application Server product files are installed</comment>
    <property name=”WasHome” value=”C:/ibm/AppServer”/>
    ...
</file>
```

In the case the bundle entry is a text file, extension unit 147 includes the contents of the text file as the value of the respective file element. For example, a file element of the following exemplary form may be used to represent the text file:

<file name=”autopdzip/ibm/portal/text.txt” type=“text“>
A single text field representing the contents of the text file.
</file>

In the case the bundle entry is a program-processed file, extension unit 147 determines the file element and the extension thereof based on an outside processing program referenced for the bundle entry. For example, a customer may provide a referenced program to process the bundle entry. The ETD may indicate a link to a referenced schema and the referenced program for processing the bundle file. An exemplary ETD XML document may be as follows:

```
<Q1:extensionTypeInclude
    fileFormatType=”programProcessed”
    fileNamePattern=”.*\.doc”
    fileNamePatternType=”FilePathgex”>
    <Q1:fileProcessRefs
        schemaRef=”./docFile.xsd”
    parserRef=”com.ibm.autopd.processor.DocFileProcessor” />
</Q1:extensionTypeInclude>
```

The respective file element and the extension from the file element will be created based on the customer provided processing program and the referenced schema. For example, the customer provided processing program may take as its starting point the file element, and the extensions therefrom may be determined based on the referenced schema document. As such, the further processing of the bundle file within the XML structure may also be based on the referenced schema. A file element of the following exemplary form may be used to represent the program-processed file in the XML document:

```
<file name=”autopdzip/ibm/portal/sample.prs”
    type=“programProcessed“>
    <!-- XML content provided by the referenced program. -->.
</file>
```

In the case the bundle entry is a lower level bundle file, extension unit 147 includes the bundle entries of the lower level bundle file as child file elements of the file element of the original/higher level bundle file. For example, assuming that a bundle file A (higher level) includes a bundle file B (lower level) as a bundle entry, and that bundle file B includes 10 bundle entries. The 10 bundle entries of bundle file B will show as 10 child file elements under the file element representing bundle file B in the virtual XML document of bundle file A. For example, a file element of the following exemplary form may be used to represent the bundle file:

```
<file name=”autopdzip/ibm/portal/bin/wpconfig.jar” type=“bundle“>
    <file name=”file1”/>
    <file name=”file2” type=”text”>Text from file2</file>
    ...
</file>
```

In the case the bundle entry is a raw byte stream file, extension unit 147 includes the contents of the raw byte stream file as the value of the respective file element. For example, a file element of the following exemplary form may be used to represent the raw byte stream file:

<file name=”autopdzip/ibm/portal/text.txt” type=“rawByteStream“>
00 0F 21 00 AE 78 5A 49 00 00 ......
</file>

In process S5, operation controller 142 determines whether there is another bundle entry to be processed. If yes, operation controller 142 controls the operation to process S4. If no, operation controller 142 controls the operation to process S6.

In process S6, processing unit 152 processes the bundle file using the virtual XML document. Any method may used to process the virtual XML document. For example, the XML Xpath approach may be used to reference and manipulate the contents of bundle entries represented in the virtual XML document. For example, the virtual XML nodes or attributes of the virtual XML documents may be queried via an XML XPath application programming interface (API). If a list of nodes and attributes meet the query criteria, the list of nodes and attributes of the virtual XML document may be modified in the same way that regular XML nodes or attributes are modified. After the modifications are completed, a program API can be used to save the modification to a new bundle file.

### 3. Conclusion

While shown and described herein as a method and system for processing a bundle file, it is understood that the disclosure further provides various alternative embodiments. For example, in an embodiment, the invention provides a program product stored on a computer-readable medium, which when executed, enables a computer infrastructure to process a bundle file. To this extent, the computer-readable medium includes program code, such as bundle file processing system 132 (FIG. 1), which implements the process described herein. It is understood that the term 37 computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 1) and/or storage system 122 (FIG. 1), and/or as a data signal traveling over a network (e.g., during a wired/wireless electronic distribution of the program product).

It should be appreciated that the teachings of the present invention could be offered as a business method on a subscription or fee basis. For example, a computing device 104 comprising bundle file processing system 132 (FIG. 1) could be created, maintained and/or deployed by a service provider that offers the functions described herein for customers. That is, a service provider could offer to provide a service to process a bundle file as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for processing a bundle file, the method comprising:
parsing the bundle file into bundle entries;
creating a virtual XML file element to represent a bundle entry in a virtual XML document; and
processing the bundle file using the virtual XML document.

2. The method of claim 1, further comprising extending the file element to include a representation of content of the bundle entry.

3. The method of claim 2, wherein the content is represented as a subtree under the file element.

4. The method of claim 2, wherein, in the case that the bundle entry is a property file including an attribute value pair representing a property, the attribute value pair are represented as child elements under the file element.

5. The method of claim 2, wherein the content is represented as a value of the file element.

6. The method of claim 2, wherein, in the case that the bundle entry is another bundle file, bundle entries of the another bundle file are represented as child elements of the file element.

7. The method of claim 2, wherein the file element and the extension thereof are determined based on an outside processing program.

8. The method of claim 1, further comprising identifying the file element as not including content of the bundle entry.

9. A system for processing a bundle file, the system comprising:
means for parsing the bundle file into bundle entries;
means for creating a virtual XML file element to represent a bundle entry in a virtual XML document; and
means for processing the bundle file using the virtual XML document.

10. The system of claim 9, further comprising means for extending the file element to include a representation of content of the bundle entry.

11. The system of claim 10, wherein the extending means extends the file element to include the content as one of:
a subtree under the file element;
a child element under the file element; or
a value of the file element.

12. The system of claim 10, wherein the extending means determines the file element and the extension thereof based on an outside processing program.

13. The system of claim 9, further comprising means for identifying the file element as not including content of the bundle entry.

14. The system of claim 9, further comprising means for determining a type of the bundle entry.

15. A computer program product stored on a computer readable medium for processing a bundle file, the computer program product comprising:
computer usable program code which, when executed by a computer system, enables the computer system to:
parse the bundle file into bundle entries;
create a virtual XML file element to represent a bundle entry in a virtual XML document; and
process the bundle file using the virtual XML document.

16. The program product of claim 15, wherein the program code is further configured to enable the computer system to extend the file element to include a representation of content of the bundle entry.

17. The program product of claim 16, wherein the program code is configured to enable the computer system to represent the content as one of
a subtree under the file element;
a child element under the file element; or
a value of the file element.

18. The program product of claim 15, wherein the program code is configured to enable the computer system to determine the file element and the extension thereof based on an outside processing program.

19. The program product of claim 15, wherein the program code is further configured to enable the computer system to identify the file element as not including content of the bundle entry.

20. A method for deploying a system for processing a bundle file, comprising:
providing a computer infrastructure being operable to:
parse the bundle file into bundle entries;
create a virtual XML file element to represent a bundle entry in a virtual XML document; and
process the bundle file using the virtual XML document.
